(19) United States
(12) Patent Application Publication
(10) Pub. No.: US 2026/0204535 A1
(43) Pub. Date: Jul. 16, 2026

(54) Ion Guide Bandpass Filter with Dynamic Window Optimization

(71) Applicant: DH Technologies Development Pte. Ltd., Singapore (SG)

(72) Inventors: David Michael COX, Toronto (CA); Yang KANG, Richmond Hill (CA)

(21) Appl. No.: 19/132,914

(22) PCT Filed: Nov. 27, 2023
(86) PCT No.: PCT/IB2023/061940

§ 371 Date: May 27, 2025

Related U.S. Application Data
(60) Provisional application No. 63/428,170, filed on Nov. 28, 2022.

(51) Int. Cl. H01J 49/42; H01J 49/00

(52) U.S. Cl. CPC H01J 49/426; H01J 49/004; H01J 49/4215

(57) ABSTRACT

In one aspect, a method of performing MRM mass spectrometry is disclosed, which includes identifying a plurality of precursor ions expected to arrive at an ion guide positioned upstream of a mass filter during a predefined time period subsequent to MRM analysis of a current precursor ion selected by the mass filter, determining a bandpass window for application to said ion guide based on a maximum m/z difference between an m/z of the current precursor ion and m/z ratios of said plurality of precursor ions to be analyzed in said subsequent time period, and configuring the ion guide to provide said bandpass window.

### RELATED APPLICATIONS

This application claims priority to U.S. Provisional Application No. 63/428,170 filed on Nov. 28, 2022, the contents of which are incorporated herein in their entirety.

### TECHNICAL FIELD

The present disclosure relates to mass spectrometry and more particularly to methods and systems for use in acquiring MRM mass spectra of compounds.

### BACKGROUND

The present teachings are generally directed to systems and methods for mass spectrometry, and more particularly, to an ion guide that can be used in a mass spectrometer.

Mass spectrometry (MS) is an analytical technique for determining the structure of test chemical substances with both qualitative and quantitative applications. MS can be useful for identifying unknown compounds, determining the composition of atomic elements in a molecule, determining the structure of a compound by observing its fragmentation, and quantifying the amount of a particular chemical compound in a mixed sample. Mass spectrometers detect chemical entities as ions such that a conversion of the analytes to charged ions must occur during the sampling process.

In some mass spectrometric systems, an ion guide can receive ions from an upstream ion source and can focus the ions into an ion beam for transmission to downstream ion optics. In some mass spectrometers, such an ion guide allows a continuous transmission of all ions received by the ion guide into the downstream ion optics. In some other mass spectrometers, the ion guide can include a set of electrodes, e.g., in the form of T-bars, that can be utilized to create a controllable high-mass cut-off (HMCO) within the ion guide, which can prevent unwanted high mass ions from being transmitted into downstream ion optics, thereby preventing contamination of those components. For example, in mass spectrometers operating in a mass reaction monitoring (MRM) mode, the ions passing through the ion guide are received by a downstream ion mass filter that can select precursor ions having target m/z ratios for fragmentation to generate daughter ions for MRM analysis. In such mass spectrometers, the voltages applied to such T-bar electrodes can be set to create a high-mass-cut-off (HMCO) higher than the precursor mass under current analysis and a calibration table can be used to correlate the T-bar voltages with the precursor mass. The ions filtered during one MRM detection cycle need to be reintroduced into the ion guide for analysis in a subsequent MRM cycle.

The ion transit time through the ion guide can influence the refilling of the ion guide with ions previously filtered and hence the duty cycle of the mass measurements. Ion transit time through the ion guide is affected by space charge as well as m/z ratios of the ions, ion beam intensity, and the pressure within the ion guide. Generally, ion transit time is shorter for ions having lower m/z ratios and higher charge states. The ion transit time can also vary with space charge and can be typically longer for lower ion intensity. Further, an elevated pressure in the ion guide can slow down ion transmission through the ion guide.

By way of example, in some cases, the ion transit time can be in a range of about 1 ms to about 30 ms. Further, in fast MRM measurements, the dwell time of ions in the ion guide can be as short as about 2 ms. Under such circumstances, ions may not have sufficient time to refill the ion guide during each MRM cycle when conventional bandpass techniques, are utilized for ion filtering.

### SUMMARY

In one aspect, a method of performing MRM mass spectrometry is disclosed, which includes identifying a plurality of precursor ions expected to arrive at an ion guide positioned upstream of a mass filter during a predefined time period subsequent to MRM analysis of a current precursor ion selected by the mass filter, determining a bandpass window for application to said ion guide based on a maximum m/z difference between an m/z of the current precursor ion and m/z ratios of said plurality of precursor ions to be analyzed in said subsequent time period, and configuring the ion guide to provide said bandpass window.

In some embodiments, the ion guide can be configured to provide a bandpass window having an m/z range greater than said maximum m/z difference. By way of example, the m/z range of the bandpass window can be about 10%, or about 20%, or about 30%, or about 50% greater than said maximum m/z difference.

In some embodiments, the predefined time period can be, for example, in a range of about 1 ms to about 100 ms, for example, in a range of about 20 ms to about 50 ms.

In some embodiments, the ion guide includes a plurality of rods arranged in a multipole configuration and configured for application of RF voltages thereto for providing a radial confining electromagnetic field, where the electromagnetic field provides a low-mass-cut-off (LMCO) and a plurality of auxiliary electrodes configured for application of DC voltages thereto for providing a high-mass-cut-off (HMCO) such that a combination of the LMCO and the HMCO provides said bandpass window. The bandpass window of the ion guide can be adjusted via adjusting the DC voltages applied to the auxiliary electrodes.

In some embodiments, the identification of the plurality of precursor ions can be based on an ion transit time through the ion guide for each of a set of precursor ions slated for MRM analysis in the subsequent time period and an ion transmission time associated with MRM analysis of each of the precursor ions.

Further, in some embodiments, the determination of the bandpass window further includes utilizing the ion transit time through the ion guide and the ion transmission time.

In some embodiments, the auxiliary electrodes can include a plurality of T-shaped electrodes. In some embodiments, the RF voltages applied to the multipole rods can have a frequency in a range of about 0.1 MHz to about 5 MHz. Further, in some embodiments, the DC voltage(s) applied to the T-shaped electrodes can be in a range of about −1000 volts to about +1000 volts.

In some embodiments, in addition to the auxiliary electrodes, the ion guide can include a set of accelerating electrodes, e.g., a set of LINAC™ electrodes, that are positioned downstream of the auxiliary electrodes and to which DC voltage(s) can be applied for generating an axial electric field for accelerating the ions passing through the bandpass window generated by the use of the auxiliary electrodes and the multipole rods, thereby reducing the ion transit time through the ion guide.

In a related aspect, a method of performing MRM mass spectrometry is disclosed, which includes identifying a plurality of precursor ions expected to arrive at an ion guide positioned upstream of a mass filter during a predefined time period subsequent to MRM analysis of a current precursor ion selected by the mass filter, determining an m/z range for establishing a bandpass window in said ion guide based on a maximum m/z difference between an m/z of the current precursor ion and m/z ratios of said plurality of precursor ions, as well as the ion transit time and MRM measurement cycle times associated the current and said plurality of precursor ions, and configuring the ion guide to provide said bandpass window.

In a related aspect, a method of performing MRM mass spectrometry is disclosed, which includes identifying a plurality of precursor ions expected to arrive at an ion guide positioned upstream of a mass filter during a predefined time period subsequent to performing MRM analysis of a current precursor ion selected by the mass filter, determining an m/z range associated with a bandpass window suitable for transmission of said plurality of precursor ions through the ion guide, and configuring the ion guide to provide the bandpass window.

In a related aspect, a mass spectrometer is disclosed, which includes an ion guide configured to receive a plurality of ions. The ion guide includes a plurality of rods arranged in a multipole configuration, e.g., a quadrupole, a hexapole or an octupole configuration, and is configured for application of one or more RF voltages thereto for generating a radial confining electromagnetic field and having a plurality of auxiliary electrodes interspersed between said plurality of rods. The auxiliary electrodes are configured for application of one or more DC voltages thereto for generating a high-mass-cut-off (HMCO) for controlling transmission of ions through the ion guide. In embodiments, the combination of the HMCO provided by the auxiliary electrodes and a low-mass-cut-off (LMCO) provided by multipole rods (i.e., the electromagnetic field generated via application of RF voltages to the multipole rods) can generate a bandpass window allowing transmission of ions having m/z ratios within the bandpass window and inhibiting transmission of ions having m/z ratios outside the bandpass window.

A mass filter can be positioned downstream of the ion guide for selecting precursor ions for MRM analysis. A controller in communication with the ion guide and the mass filter can be configured to adjust the bandpass of the ion guide based on a maximum m/z difference between an m/z of a current precursor ion under MRM analysis and m/z ratios of the plurality of precursor ions to be analyzed in a predetermined time period subsequent to the analysis of the current precursor ion.

In some embodiments, the controller can determine the bandpass window of the ion guide, i.e., the range of m/z ratios that can pass through the ion guide, based on information provided by the combination of the maximum m/z difference between the m/z of the current precursor ion and the m/z ratios of the plurality of precursor ions to be analyzed in the predetermined time period subsequent to analysis of the current precursor ion as well as the ion transit time and the ion transmission time for those precursor ions.

In some embodiments, the mass spectrometer can include an RF voltage source operating under control of the controller for applying RF voltages to said plurality of rods. Further, the mass spectrometer can include a DC voltage source, which can also operate under the control of the controller, for applying DC voltages to the auxiliary electrodes. The controller can be in communication with the DC voltage source to control the DC voltage source for adjusting the DC voltages applied to the auxiliary electrodes, thereby adjusting the ion guide's bandpass window.

The controller can be configured to identify the m/z ratios of the plurality of the precursor ions to be analyzed in the predefined time period, for example, based on the ion transit time and the ion transmission time associated with a set of precursor ions that are slated for MRM analysis.

The methods and systems according to the present teachings including various embodiments disclosed herein can be employed with both positive and negative ion polarities. In addition, in some embodiments, the ion polarity may be switched during an MRM analysis.

Further understanding of various aspects of the present teachings can be achieved by reference to the following detailed description in conjunction with the associated drawings, which are described briefly below.

### BRIEF DESCRIPTION OF THE DRAWINGS

FIG. 1 schematically depicts that a bandpass window associated with an ion guide according to the present teachings can cover different numbers of MRM transitions based, e.g., on the ion transit time and dwell time,

FIG. 2 is a flow chart depicting various steps of a method according to an embodiment of the present teachings for performing MRM mass spectrometry,

FIG. 3 schematically depicts an ion guide according to an embodiment of the present teachings having a controller that is programmed to implement a method according to an embodiment for performing MRM mass spectrometry,

FIGS. 4A and 4B schematically depict an ion guide according to another embodiment having a controller that is programmed to implement a method according to an embodiment for performing MRM mass spectrometry,

FIG. 5 schematically depicts a triple quadrupole mass spectrometer according to an embodiment in which an ion guide according to the present teachings is incorporated, where the ion guide provides a bandpass window that can be dynamically adjusted,

FIG. 6 schematically depicts an example of an implementation of a controller suitable for use in the practice of the present teachings, where the controller is configured to provide instructions to a DC voltage source for controlling DC voltages applied to a set of auxiliary electrodes disposed in the ion guide so as to adjust a bandpass window provided by the ion guide,

FIG. 7 shows examples of ion transmit times through a Q0 ion guide of a prototype mass spectrometer for an ion having an m/z of 922, and

FIG. 8 shows ion transit times through a Q0 ion guide measured for m/z 829.5 at low total ion current (TIC) on a triple quadrupole mass spectrometer in which the Q0 ion guide included a set of LINAC™ electrodes.

### DETAILED DESCRIPTION

It will be appreciated that for clarity, the following discussion will explicate various aspects of embodiments of the applicant's teachings, while omitting certain specific details wherever convenient or appropriate to do so. For example, discussion of like or analogous features in alternative embodiments may be somewhat abbreviated. Well-known ideas or concepts may also for brevity not be discussed in any great detail. The skilled person will recognize that some embodiments of the applicant's teachings may not require certain of the specifically described details in every implementation, which are set forth herein only to provide a thorough understanding of the embodiments. Similarly, it will be apparent that the described embodiments may be susceptible to alteration or variation according to common general knowledge without departing from the scope of the disclosure. The following detailed description of embodiments is not to be regarded as limiting the scope of the applicant's teachings in any manner.

As used herein, the terms “about” and “substantially equal” refer to variations in a numerical quantity that can occur, for example, through measuring or handling procedures in the real world; through inadvertent error in these procedures; through differences in the manufacture, source, or purity of compositions or reagents; and the like. Typically, the terms “about” and “substantially” as used herein mean 10% greater or less than the value or range of values stated or the complete condition or state. For instance, a concentration value of about 30% or substantially equal to 30% can mean a concentration between 27% and 33%. The terms also refer to variations that would be recognized by one skilled in the art as being equivalent so long as such variations do not encompass known values practiced by the prior art.

As used herein the term “and/or” includes any and all combinations of one or more of the associated listed items and may be abbreviated as “/”.

Various terms are used herein according to their ordinary meanings in the art. The term “ion transit time” is used herein to refer to a time interval required for the passage of an ion through the ion guide. The term “dwell time” is used herein to refer to the time spent for counting ions for a particular MRM transition at the detector of a mass spectrometer. The term “pause time” is used herein to refer to the time required to fill or refill the ion guide with precursor ions slated for MRM analysis. The term “ion transmission time” is used herein to refer to a combination of the dwell time and the pause time, that is, ion transmission time is equal to a sum of the dwell time and the pause time.

The term “high-mass-cut-off” as used herein refers to a maximum m/z ratio associated with an ion filter such that all ions having m/z ratios less than that maximum m/z ratio can pass through the filter and ions having m/z ratios greater than the maximum m/z ratio are inhibited from passing through the filter.

The term “low-mass-cut-off” as used herein refers to a minimum m/z ratio associated with an ion filter such that all ions having m/z ratios greater than that minimum m/z ratio can pass through the filter and ions having m/z ratios less than the minimum m/z ratio are inhibited from passing through the filter.

The term “bandpass filter” refers to an ion filter that allows the passage of ions having m/z ratios within an m/z range through the filter while inhibiting ions having m/z ratios outside that m/z range from passing through the filter. The m/z range is herein also referred to the bandpass window.

As noted above, the ion transit time through an ion guide of a mass spectrometer positioned upstream of an ion filter, during MRM mass analysis, with ions that were previously filtered can influence the refilling of the ion guide and hence the duty cycle of the mass measurements. Ion transit time through the ion guide is affected by space charge as well as m/z ratios of the ions, ion beam intensity, and the pressure within the ion guide. Generally, ion transit time is shorter for ions having lower m/z ratios and higher charge states. The ion transit time can also vary with space charge and is typically longer for lower TIC. Further, an elevated pressure in the ion guide can slow down ion transmission through the ion guide.

By way of example, in some cases, the ion transit time can be in a range of about 1 ms to about 30 ms. Further, in fast MRM measurements, the dwell time of ions in the ion guide can be as short as about 2 ms. Under such circumstances, ions may not have sufficient time to refill the ion guide during each MRM cycle when conventional techniques are utilized for ion filtering.

In mass spectrometers utilizing ion guides (herein referred to for ease of description as Q0 or Q0 ion guide) for focusing ions generated by an upstream ion source for delivery to a downstream ion mass filter (herein referred to for ease of description as Q1 or Q1 mass filter), auxiliary electrodes can be utilized, e.g., in the form of T-shaped electrodes (herein also referred to as T-bars), to create a controllable high-mass cut-off (HMCO) that can prevent unwanted high mass ions from being transmitted into downstream ion optics, which could otherwise lead to contamination of those ion optics. In other words, while conventional ion guides can allow all ions received from an upstream ion optic to continuously pass through, T-bars incorporated in such ion guides can be used to create a HMCO that allows only those ions having m/z ratios below the cut-off to pass through the ion guide. For example, voltages applied to the T-bars can create a HMCO in Q0 that is above the largest m/z ratio to be selected by Q1 for multiple reaction monitoring (MRM) analysis and a calibration table can be used to correlate the T-bar voltages with the ion mass. The ion guide can further include a set of rods arranged in a multipole configuration to which RF voltages can be applied to generate a radial confining field. The RF field can also provide a low-mass-cut-off (LMCO), which in combination with the HMCO provided by the auxiliary electrodes, can result in a bandpass filter.

Ions filtered out using such a bandpass filter during MRM monitoring of a precursor ion need to be re-introduced into Q0 to be able to perform their MRM analysis. Thus, the ion transit time in Q0 is a parameter that can affect the duty cycle of the MRM mass spectrometry.

Ion transit time is affected by space charge as well as m/z ratios of ions, ion beam intensity, and Q0 pressure levels. In fast MRM analysis of a compound, the dwell time (i.e., the time required for monitoring a particular MRM transition) can be as short as 2 ms. Under such circumstances, ions may not have sufficient time to refill Q0 during each MRM using conventional Q0 bandpass filtering. In some techniques, this problem is addressed by employing a “single” high-mass-cut-off to ensure that all ions for which analysis is desired are consistently transmitted through multiple bandpass windows by adjusting the window sizes based on Q1 precursor m/z. The HMCO can be determined by the highest m/z in the ion list. This method uses a relatively large bandpass window to provide sufficient time for refilling Q0, but it may limit the effectiveness of bandpass filter and hence protection of the downstream optics from contamination. By way of example with T-bar filtering, assuming that MRM analysis of a group of ions is desired, where most of the ions have m/z ratios in a range of 400-1000 with a few ions having m/z ratio of 1500, the HMCO of Q0 can be set, for example, at m/z of 1600 or higher. In such a case, the HMCO offset would be 1200 Da for m/z 400 and 600 Da for m/z 1000. For lower m/z ratios, the T-bar voltages would be close to zero for large bandpass window sizes.

This disclosure is generally related to an ion guide that can provide a time-dependent dynamic bandpass window for use in MRM (multiple reaction monitoring) mass spectrometry. As discussed in detail below, a controller can automatically adjust the bandpass window of the ion guide, i.e., the m/z range of precursor ions that are permitted to pass through the ion guide, to ensure that the ion guide can be sufficiently refilled with precursor ions during each MRM cycle. The bandpass window may cover one m/z ratio associated with one precursor ion or may cover multiple m/z ratios associated with multiple different precursor ions. The number of MRM transitions in each MRM measurement cycle can depend on the ion transit time through the ion guide as well as the dwell time per MRM transition, the time utilized to acquire data for measuring one MRM transition.

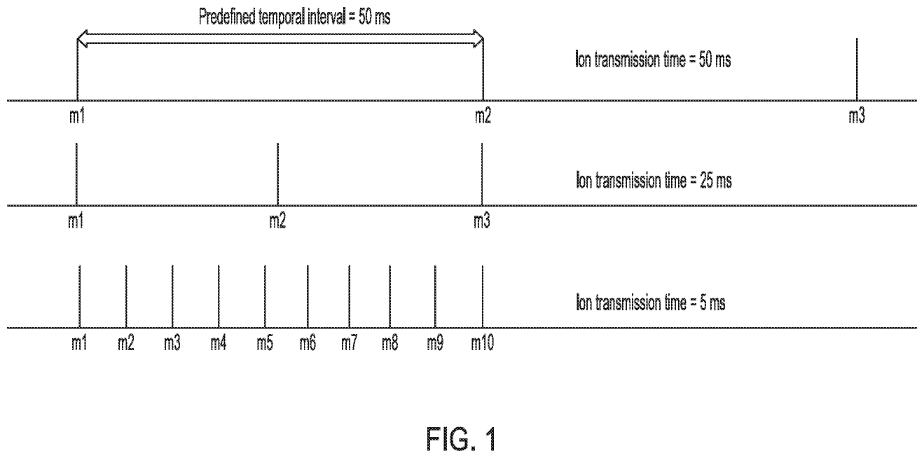

By way of example, as shown schematically in FIG. 1, when the predefined temporal interval is set to 50 ms, the bandpass window can be set to cover one MRM transition, i.e., to allow passage of only one m/z ratio through the ion guide, for an ion measurement time (or ion transmission time) of 50 ms, and to cover two MRM transitions, i.e., to allow the passage of two different m/z ratios through the ion guide, for an ion measurement time of 25 ms, or to cover 10 MRM transitions, i.e., to allow the passage of 10 different m/z ratios, for an ion measurement time of 5 ms. The target time period can be comparable or longer than transit time of ions to be analyzed, e.g., 1×, 2× or 3× of ion transit time.

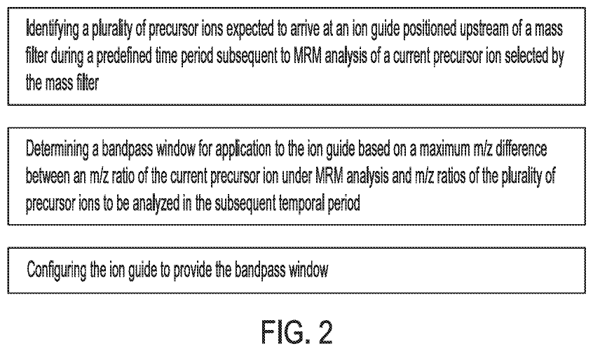

With reference to flow chart of FIG. 2, a method according to an embodiment of the present teachings for performing MRM mass spectrometry can include identifying a plurality of precursor ions that are expected to arrive at an ion guide positioned upstream of a mass filter (herein also referred to as an “ion mass filter”) during a predefined time period subsequent to MRM analysis of a current precursor ion selected by the mass filter (i.e., analysis of precursor ions with an m/z selected by the downstream mass filter). A bandpass window is determined for application to the ion guide based on a maximum m/z difference between an m/z ratio of the current precursor ion under MRM analysis and m/z ratios of said plurality of precursor ions to be analyzed in the subsequent temporal period. The ion guide can be configured to provide the determined bandpass window. As discussed in more detail below, in some embodiments, the step of configuring the ion guide to provide the bandpass window can include adjusting DC voltages applied to a plurality of auxiliary electrodes positioned in the ion guide.

In some embodiments, the above method can be implemented by generating a list of m/z ratios associated with a set of precursor ions for which MRM analysis is desired. For each of the precursor ions on the list, the ion transit time through the ion guide can be estimated as discussed in more detail below. By way of example, the transit time can be measured in an experiment including two periods, empty period and detection period. In the first step, target ions are removed from the ion guide and downstream ion optics, for example, by dropping the RF amplitude. Then in the second step, ions start to be transmitted through the ion guide and signals of target ions are monitored in short time intervals (e.g., 0.1 ms to 1 ms). The transit time can be estimated at the point where ion signals are recovered, e.g., at 80% of the maximum signals. The transit time varies by m/z, ion intensity and ion guide pressure. A DOE (Design of experiments) study can be conducted with these multiple factors to estimate the transit time of each ion at certain conditions.

The estimated transit time is used to define a target refill time period (herein also referred to as predefined temporal interval), which for example, can be 1×, 2× or 3× of ion transit time. The predefined temporal interval and predefined ion transmission time for each of the ions can then be utilized to compute the number of precursor ions that are expected to be subjected to MRM analysis of the current precursor ion. The ion transmission time can be calculated by summing the MRM dwell time and pause time between two MRM analysis.

The bandpass window of the ion guide can then be set based on the maximum m/z difference between the m/z ratio of a current precursor ion under MRM analysis and the m/z ratios of the precursor ions (herein referred to as “upcoming precursor ions”) to be analyzed in the subsequent predefined temporal period. For example, the bandpass window can be configured to allow ions having m/z ratios between the m/z ratio of the current precursor ion and the maximum m/z ratio of the upcoming ions to pass through the ion guide. Note that the temporal interval can be dynamic based on the transit time of each ion in the MRM list so the numbers of precursors required to be transmitted in one bandpass window can be dynamic. The bandpass window is adjusted to allow any of the following precursors have sufficient time to refill into the ion guide prior to the detection period.

In some embodiments in which the ion guide includes a plurality of rods arranged in a multipole configuration to which RF voltages can be applied for providing a radial confinement of ions, as well as a plurality of auxiliary electrodes, e.g., in the form of T-shaped electrodes, interspersed between those rods to which DC voltages can be applied, the DC voltages applied to the auxiliary electrodes can be controlled to adjust the bandpass window provided by the ion guide. By way of example, a controller in communication with a DC voltage source supplying DC voltages to the auxiliary electrodes can be programmed to determine the requisite voltages required for application to the auxiliary electrodes of the ion guide during different time intervals based on the present teachings.

When the method involves acquiring data for a simple list of MRM transitions, the MRM measurements can be performed in the order they appear in the list. For a given MRM, the controller can look ahead in the list at the next MRM and keep track of the highest Q1 mass and the dwell (+pause) time being used. The controller can continue looking ahead to next MRM until a sum of dwell times that is greater than the transit time for the Q0 on the particular instrument is reached. The controller can set the HMCO based on the largest Q1 mass+some tolerance. The controller can repeat this process for every MRM in the list.

When the method involves performing scheduled MRM measurements, the data corresponding to the MRM transitions on the list are not acquired all at the same time. Each MRM transition has a defined retention time window during which the MRM data will be acquired. A similar procedure as that described above for the simple list of MRM transitions can be applied, but it is run at every possible retention time. The controller can still look ahead (e.g., 50 msec) relative to each running MRM (i.e., a current MRM transition being measured), can still keep track of the largest future Q1 mass for this MRM, but doing this for all possible retention times.

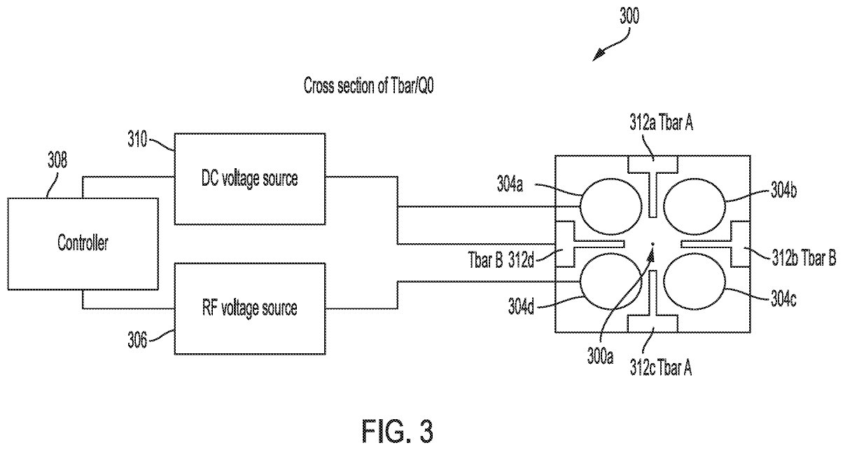

FIG. 3 schematically depicts an end view of an ion guide 300 according to an embodiment of the present teachings, which includes an inlet 300a for receiving ions generated by an upstream ion source (not shown) and an outlet (not shown) through which ions can exit the ion guide. An inlet lens (not shown) can be positioned in the proximity of the ion guide's inlet to help focus the ions into the ion guide and an outlet lens (not shown) can be positioned in the proximity of the ion guide's outlet to help focus the ions exiting the ion guide.

The ion guide 300 includes a set of rods 304a/304b/304c/304d (referred to collectively as rods 304), which are arranged according to a multipole configuration and are spaced apart to provide an ion passageway through which ions can travel. In this embodiment, the rod set 304 is arranged according to a quadrupole configuration and extends from the proximity of the ion guide's inlet to the proximity of the ion guide's outlet.

An RF voltage source 306 operating under control of a controller 308 applies RF voltages to the rods 304 of the quadrupole rod set to generate an electromagnetic field within the ion passageway for providing a radial confinement of the ions as they travel through the ion guide.

The quadrupole rods can be characterized as comprising a plurality of pairwise poles where the RF voltages applied to the rods of each pole are substantially equal (the rods of each pole are equipotential) while the phase of the voltages applied to one pole is the opposite of the phase of the voltages applied to the other pole.

The RF voltages applied to the quadrupole rods can generate a quadrupolar electromagnetic field within the ion passageway that can facilitate the radial confinement of the ions.

In some embodiments, the RF voltages applied to the multipole rods can have a frequency in a range of about 0.1 MHz to about 5 MHz, e.g., in a range of about 1 MHz to about 3 MHz, or in a range of about 3 MHz to about 5 MHz. In some such embodiments, the RF voltages can have an amplitude in a range of about 10 volts to about 5 kilovolts (V₀₋ₚ), e.g., in a range of about 100 to 2000 V₀₋ₚ.

A DC voltage source 310, also operating under control of the controller 308, can apply offset DC voltages to the quadrupole rods so as to provide an offset DC voltage between the quadrupole rods and an upstream and/or a downstream ion optic (e.g., a downstream ion mass filter).

With continued reference to FIG. 3, a plurality of auxiliary electrodes 312a, 312b, 312c, and 312d, which are herein collectively referred to as the T-shaped auxiliary electrodes or T-shaped electrodes 312, is interspersed between the quadrupole rod set such that each auxiliary electrode is interposed between two of the quadrupole rods. In this embodiment, the auxiliary electrodes have a T-shaped configuration characterized by a base that extends parallel to the quadrupole rods and a stem that extends orthogonally from the base toward the ion passageway. In this embodiment, the auxiliary electrodes 312 can be grouped into two pairs, which are herein referred to as T-bar A and T-bar B.

More specifically, the pair of the auxiliary electrodes 312a/312c forms one pole of the auxiliary electrodes (herein referred to as the A-pole) and the pair 312d/312e (herein referred to as the B-pole) forms the other pole of the auxiliary electrodes.

In this embodiment, the auxiliary electrodes 300 extend across the entire length of the ion guide.

The DC voltage source can apply DC voltages to the T-shaped auxiliary electrodes such that the DC potential difference between the auxiliary electrodes (as well as the potential difference between the auxiliary electrodes and the quadrupole rods) can generate a DC field (e.g., an octupolar DC field distribution) within the ion passageway such that the DC field provides a high-mass-cut-off filter, which in combination with the RF electromagnetic field generated, via application of RF voltages to the quadrupole rods, that provides a low mass cut off filter, generates a bandpass filter within the ion passageway.

The controller 308 can be configured to adjust the bandpass window (the width of the bandpass filter) of the Q0 ion guide dynamically in accordance with the present teachings. For example, the controller can receive a list of m/z ratios of precursor ions for which MRM analysis is desired. For each of a plurality of predefined time periods (temporal intervals) during the MRM analysis of the ions, the controller can determine the m/z ratios that are expected to undergo MRM analysis during that time period, e.g., in a manner discussed herein.

The controller 308 can then compute voltages required for application to the T-bar auxiliary electrodes, in a manner known in the art as informed by the present teachings, for configuring the ion guide to provide a bandpass window based on the maximum difference between an m/z ratio of a current precursor ion (i.e., a precursor ion that is currently being analyzed) and a set of upcoming precursor ions (i.e., the precursor ions expected to undergo MRM analysis in a predefined time interval relative to current time) as well as the ion transit time through Q0 and the ion transmission time. The controller can then cause the DC voltage source to apply the computed DC voltages to the T-bar electrodes to configure the Q0 ion guide to provide the desired bandpass window. The controller can update the bandpass window dynamically using the methods disclosed herein.

The implementation of dynamic adjustment of an ion guide's bandpass window according to the present teachings is not limited to the above ion guide Q0 but can be implemented in a variety of ion guides employed in a variety of different mass spectrometers.

By way of example, in some embodiments, an ion guide according to the present teachings can include a set of ion accelerating electrodes (e.g., a set of LINAC™ electrodes) in addition to the auxiliary T-shaped electrodes for accelerating the ions passing through the ion guide, thereby reducing their transit time.

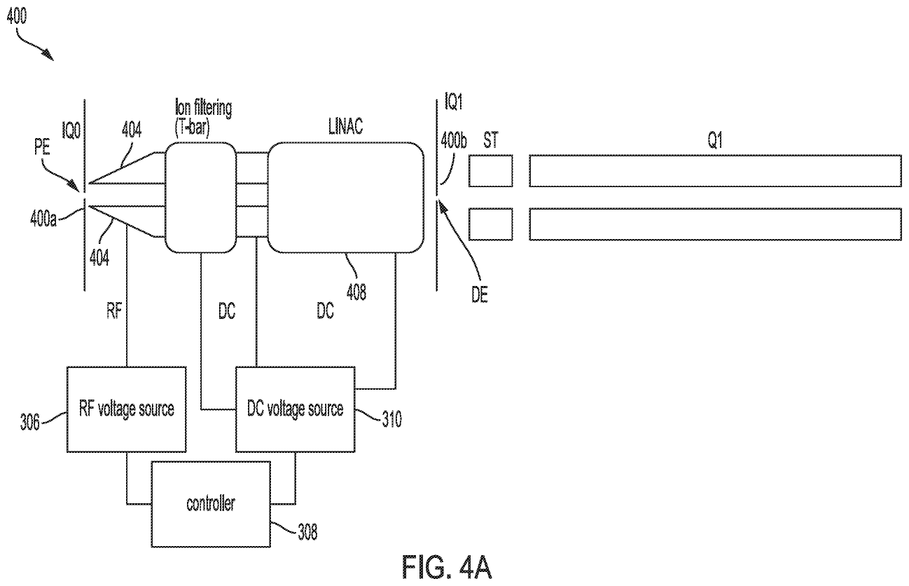

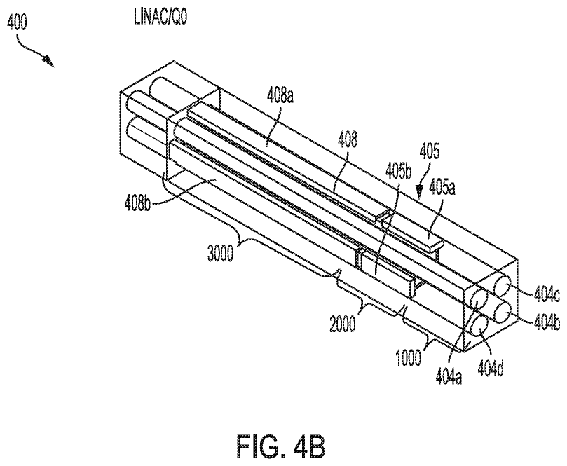

With reference to FIGS. 4A and 4B, such an ion guide 400 can include an inlet 400a for receiving ions generated by an upstream ion source (not shown) and an outlet 400b through which ions can exit the ion guide. A lens IQ0 positioned in proximity of the ion guide's inlet helps focus the incoming ions into the ion guide and a lens IQ1 positioned in proximity of the ion guide's outlet helps focus, together with a stubby lens ST, the ions exiting the ion guide into a downstream mass filter Q1.

The ion guide 400 includes a set of rods 404a, 404b, 404c and 404d (herein referred to collectively as rods 404) that are arranged according to a quadrupole configuration and are spaced apart to provide an ion passageway through which ions can travel. In this embodiment, each of the rods 404 extends, as a continuous element, from a proximal end (e.g., proximal end depicted as PE) to a distal end (e.g., a distal end depicted as DE). The proximal ends of the quadrupole rods are positioned at or in proximity of the inlet 400a of the ion guide and the distal ends of the quadrupole rods are positioned at or in proximity of the outlet 400b of the ion guide. For example, the distance between the proximal end of the rods 404 and the inlet of the ion guide, which can be defined herein as the distance between the orifice of the lens IQ0 and the most proximal end of the rods 404, can be, for example, in a range of about 0.5 mm to about 2 mm. Similarly, the distance between the distal end of the rods 404 and the outlet of the ion guide, which can be defined herein as the distance between the orifice of the lens IQ1 and distal most end of the rods, can be, for example, in a range of about 0.5 mm to about 2 mm. Thus, the rods of the quadrupole rod set extend continuously from the inlet (or from a point in proximity of the inlet) of the ion guide to the outlet (or to a point in proximity of the outlet) of the ion guide, ensuring radial focusing of at least a portion of the ions along the entire length of the ion guide. In other words, the rods of the quadruple rod set are not in the form of a plurality of segments positioned relative to one another with gaps separating adjacent segments from one another.

Similar to the previous embodiment, the RF voltage source 306 operating under control of the controller 308 applies RF voltages to the rods of the quadrupole rod set to generate an electromagnetic field within the ion passageway for providing a radial confinement of the ions as they travel through the ion guide.

The quadrupole rods can be characterized as comprising a plurality of pairwise poles where the RF voltages applied to the rods of each pole are substantially equal (the rods of each pole are equipotential) while the phase of the voltages applied to one pole is the opposite of the phase of the voltages applied to the other pole.

The RF voltages applied to the quadrupole rods can generate a quadrupolar electromagnetic field within the ion passageway that can facilitate the radial confinement of the ions.

In some embodiments, the RF voltages applied to the multipole rods can have a frequency in a range of about 0.1 MHz to about 5 MHz, e.g., in a range of about 1 MHz to about 3 MHz, or in a range of about 3 MHz to about 5 MHz. In some such embodiments, the RF voltages can have an amplitude in a range of about 10 volts to about 5 kilovolts (V₀₋ₚ), e.g., in a range of about 100 to 2000 V₀₋ₚ.

The DC voltage source 310, also operating under control of the controller 308, can apply offset DC voltages to the quadrupole rods so as to provide an offset DC voltage between the quadrupole rods and an upstream and/or a downstream ion optic (e.g., a downstream ion mass filter).

A plurality of auxiliary electrodes 405 (two of which 405a, 405b are visible in the figure and which are herein also collectively referred to as the T-shaped auxiliary electrodes or T-shaped electrodes or T-bar electrodes), is interspersed between the quadrupole rod set such that each auxiliary electrode is interposed between two of the quadrupole rods. In this embodiment, the auxiliary electrodes have a T-shaped configuration characterized by a base that extends parallel to the quadrupole rods and a stem that extends orthogonally from the base toward the ion passageway. Similar to the previous embodiment, in this embodiment, the auxiliary electrodes 405 can be grouped into two pairs, which are herein referred to as T-bar A and T-bar B.

Unlike the previous embodiment, in this embodiment, the auxiliary electrodes 405 do not extend across the entire length of the ion guide. In other words, the length of the base of the T-shaped electrodes is less than the longitudinal length of the ion guide. The auxiliary electrodes 405 may be positioned in a region of the ion guide that is closer to the ion guide's inlet than its outlet.

The DC voltage source can apply DC voltages to the T-shaped auxiliary electrodes such that the DC potential difference between the auxiliary electrodes (as well as the potential difference between the auxiliary electrodes and the quadrupole rods) can generate a DC field (e.g., an octupolar DC field distribution) within a region 2000 of the ion passageway that can cause a reduction in radial confinement experienced by a subset of ions (herein also referred to as the first subset) having m/z ratios within a target range that are received by the ion guide, thereby inhibiting the passage of those ions through the ion guide, while allowing other ions received by the ion guide to continue propagating through the ion passageway. For example, the reduction in the ion confinement of the first subset of ions can lead to those ions following trajectories that result in the ions being attracted to the auxiliary electrodes and striking those electrodes, thereby being removed from the set of ions propagating toward the outlet of the ion guide. The T-bar electrodes can be used to establish a HMCO and the multipole rods can be used to establish a LMCO such that the combination of the HMCO and the LMCO provides a bandpass filter that allows transmission of ions with m/z ratios within an m/z range while inhibiting the passage of ions with m/z ratios outside of that m/z range.

By way of example, the DC bias voltage applied to the T-shaped auxiliary electrodes can be in a range of about −1000 V to about +1000 V. In some embodiments, the DC bias voltage can be split across both poles of the T-bars with the Q0 DC offset as the zero (reference) point. The remaining ions (herein referred to as a second subset of ions) continue to propagate along the ion guide. The voltages applied to the T-shaped auxiliary electrodes can establish a HMCO that in combination with the LMCO established by the RF voltages applied to the multipole rods generates a bandpass filter that inhibits the passage of one subset of ions but allows the passage of another subset.

With particular reference to FIGS. 4A and 4B, in this embodiment, a set of LINAC™ (linear accelerator) electrodes 408 is positioned downstream of the T-shaped electrodes. In this embodiment, the set of LINAC™ electrodes includes four electrodes (two of which 408a/408b are visible in the figure) each of which is interposed between two of the quadrupole rods. In this embodiment, each of the LINAC™ electrodes has a tapered profile such that the application of DC voltages to those electrodes results in generation of an axial electric field within a region 3000 of the ion guide, which is positioned downstream of the second region 2000 and corresponds substantially to a portion of the ion passageway that is surrounded by the LINAC™ electrodes, to axially accelerate the ions that pass through bandpass filter established in the ion guide toward the outlet of the ion guide.

By way of example, and without limitation, the DC voltages applied to the LINAC™ electrodes can be in a range of about −500 volts to about +500 volts.

In embodiments, the generation of an axial electric field in the region 3000 of the ion guide can reduce the transit time of ions passing through the ion guide by a factor in a range of about 2× to about 30×. For example, in embodiments, due to the use of the axial accelerating field, the passage time of ions through the ion guide can be, for example, equal to or less than about 5 ms, e.g., in a range of about 1 ms to about 5 ms. This can in turn allow rapid refilling of the ion guide. In this manner, a bandpass filter provided by the combination of the multipole rods and the T-shaped electrodes can significantly reduce the contamination of the downstream ion optics while the axial electric field provided by the LINAC™ electrodes allows rapid filling of the ion guide with those ions removed by the bandpass filter.

Similar to the previous embodiment, the controller 308 is programmed to dynamically adjust the width of the bandpass filter provided by the Q0 ion guide, via adjustment of DC voltages applied to the T-shaped auxiliary electrodes, thereby improving the duty cycle of the MRM mass measurements.

An ion guide according to the present teachings can be incorporated in a variety of different mass spectrometers, such as a triple quadrupole, a quadrupole-time-of-flight mass spectrometer, among others.

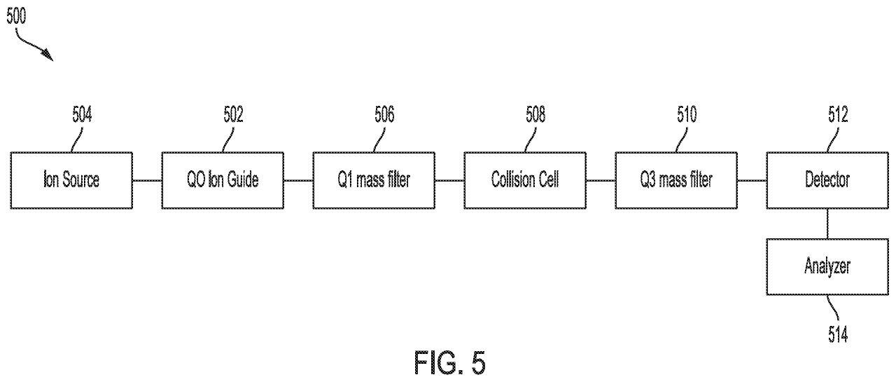

By way of example, FIG. 5 schematically depicts a triple-quadrupole mass spectrometer 500 in which an ion guide 502 according to the present teachings is incorporated. More specifically, the mass spectrometer 500 includes an ion source 504 that receives a sample, e.g., from an LC column, and ionizes at least a portion thereof to generate a plurality of precursor ions that are received by the ion guide 502. The ion guide 502 is configured in a manner disclosed herein to provide a bandpass filter to allow passage of ions having certain m/z ratios to a downstream ion mass filter 506. The mass filter can select precursor ions based on their m/z ratios for passage to a collision cell 508, which can include a quadrupole rod set and a gas, such as nitrogen, with which the ions can collide. As least a portion of the selected precursor ions undergo fragmentation in the collision cell 508 so as to generate a plurality of fragment ions. The fragment ions are in turn received by a quadrupole mass filter 510 that can select fragment ions for detection by a downstream detector 512, which in turn generates ion detection signals that can be received by a mass analyzer 514 to generate a mass spectrum of the fragment ions.

A controller suitable for use in the practice of the present teachings can communicate with a DC voltage source for adjusting DC voltages applied to a set of auxiliary electrodes positioned in the Q0 ion guide for dynamically changing the bandpass window of the ion guide in accordance with the present teachings.

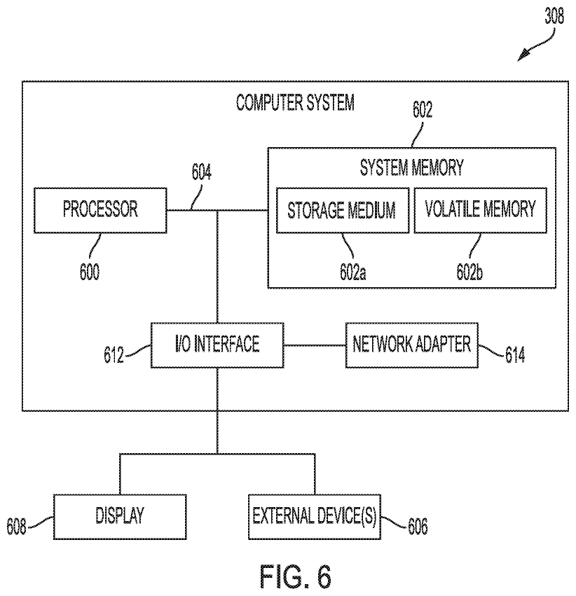

By way of example, FIG. 6 schematically depicts an example of an implementation of the controller 308 according to the present teachings that is configured for dynamically adjusting the bandpass window of the ion guide can include one or more processors or processing units 600, a system memory 602, and a bus 604 that allows communication between various components of the controller including the system memory 602 to the processor 600.

The system memory 602 includes a computer readable storage medium 602a and volatile memory 602b (e.g., Random Access Memory, cache, etc.). As used herein, a computer readable storage medium includes any media that is capable of storing computer readable program instructions and is accessible by a computer system. The computer readable storage medium 602a includes non-volatile and non-transitory storage media (e.g., flash memory, read only memory (ROM), hard disk drives, etc.). Computer readable program instructions as described herein include program modules (e.g., routines, programs, objects, components, logic, data structures, etc.) that are executable by a processor. Furthermore, computer readable program instructions, when executed by a processor, can direct a computer system (e.g., the controller 126) to function in a particular manner such that a computer readable storage medium comprises an article of manufacture. Specifically, when the computer readable program instructions stored in the computer readable storage medium 602a are executed by the processor 600, they create means for implementing the functions specified in the present teachings. For example, the instructions can include utilizing the present teachings for identifying a plurality of precursor ions expected to arrive at an ion guide positioned upstream of a mass filter during a predefined time period subsequent to MRM analysis of a current precursor ion selected by the mass filter, determining a bandpass window for application to said ion guide based on a maximum m/z difference between an m/z of the current precursor ion and m/z ratios of said plurality of precursor ions to be analyzed in said subsequent time period, and configuring the ion guide to provide said bandpass window, e.g., via adjustment of DC voltages applied to a DC voltage source supplying DC voltages to auxiliary electrodes within the ion guide.

The bus 604 may be one or more of any type of bus structure capable of transmitting data between components of the controller (e.g., a memory bus, a memory controller, a peripheral bus, an accelerated graphics port, etc.).

In some embodiments the controller 308 may include one or more external devices 606 and a display 608. As used herein, an external device includes any device that allows a user to interact with the controller (e.g., mouse, keyboard, touch screen, etc.). The external devices 606 and the display 610 are in communication with the processor 600 and the system memory 602 via an Input/Output (I/O) interface 612. In some embodiments, the controller can further include a network adapter 614 to allow establishing communication between the controller and other devices.

### EXAMPLES

### Example 1

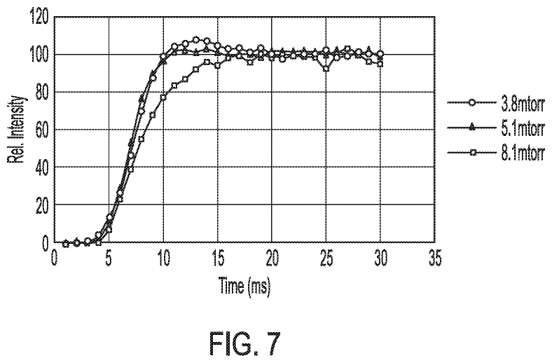

FIG. 7 shows examples of ion transmit times through a Q0 ion guide of a prototype mass spectrometer for an ion having an m/z of 922.

The data presented in FIG. 7 was acquired on a system that did not include LINAC electrodes, such as those discussed above, and included a 12 cm Q0 ion guide. As the pressure of the Q0 region increased, longer time frames were required to refill the ion optics.

The above data shows that the ions required at least about 5-10 ms to transit through the Q0 regions when using a 12 cm Q0 with various pressures. The transit time can be further slowed down to 10-30 ms when using a longer Q0 assembly, such as 15-18 cm, or with reduced ion currents. For example, in the data depicted in FIG. 2, as the pressure within Q0 increases, the time required to refill the Q0 ion guide also increases.

### Example 2

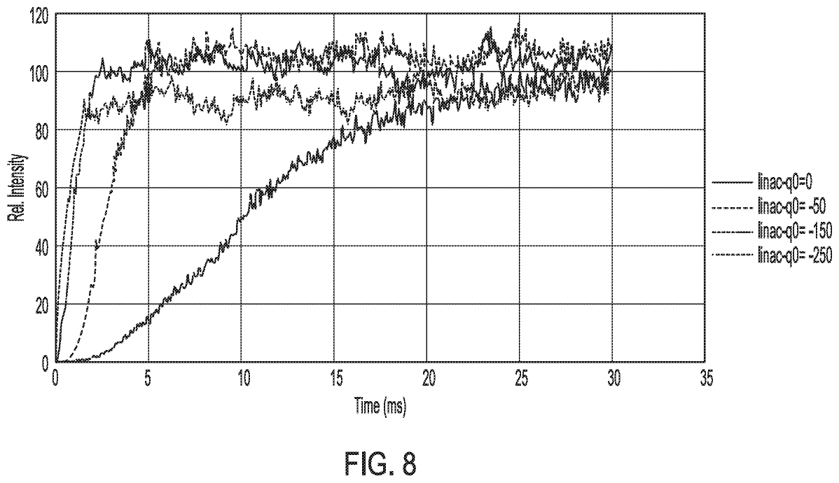

FIG. 8 shows ion transit time measured for m/z 829.5 at low total ion current (TIC) on a TOF/MS/MS system in which the Q0 ion guide included a set of LINAC™ electrodes, which were assembled on the exit section of the Q0 ion guide, e.g., as shown in the ion guide depicted in FIG. 4A, to accelerate ions passing through the Q0 ion guide, thereby reducing the time needed for refilling of the ion guide. As shown in the data presented in FIG. 8, the use of the LINAC™ electrodes allowed reducing the ion transit time to about 5 ms. T-bar voltages were set to create a HMCO higher than the m/z ratio of the precursor ion selected by a downstream mass filter (Q1) by about 100 Da.

As used herein the term “and/or” includes any and all combinations of one or more of the associated listed items and may be abbreviated as “/”. Although some aspects have been described in the context of an apparatus, it is clear that these aspects also represent a description of the corresponding method, where a block or device corresponds to a method step or a feature of a method step. Analogously, aspects described in the context of a method step also represent description of a corresponding block or item or feature of a corresponding apparatus. Some or all of the method steps may be executed by (or using) a hardware apparatus, like for example, a processor, a microprocessor, a programmable computer or an electronic circuit. In some embodiments, some one or more of the most important method steps may be executed by such an apparatus.

Depending on certain implementation requirements, embodiments of the invention can be implemented in hardware and/or in software. The implementation can be performed using a non-transitory storage medium such as a digital storage medium, for example a floppy disc, a DVD, a Blu-Ray, a CD, a ROM, a PROM, and EPROM, an EEPROM or a FLASH memory, having electronically readable control signals stored thereon, which cooperate (or are capable of cooperating) with a programmable computer system such that the respective method is performed. Therefore, the digital storage medium may be computer readable.

While various embodiments have been illustrated and described in detail in the drawings and foregoing description, such illustration and description are to be considered illustrative or exemplary and not restrictive; embodiments of the present disclosure are not limited to the disclosed embodiments. Other variations to the disclosed embodiments can be understood and effected by those skilled in the art in practicing embodiments of the present disclosure, from a study of the drawings, the disclosure, and the appended claims.

In the claims, the word “comprising” does not exclude other elements or steps, and the indefinite article “a” or “an” does not exclude a plurality. A single processor or other processing unit may fulfill the functions of several items recited in the claims. The mere fact that certain measures are recited in mutually different dependent claims does not indicate that a combination of these measured cannot be used to advantage. Any reference signs in the claims should not be construed as limiting the scope.

Those having ordinary skill in the art will appreciate that various changes can be made to the above embodiments without departing from the scope of the present teachings.

What is claimed is:

1. A method of performing MRM mass spectrometry, comprising:
identifying a plurality of precursor ions expected to arrive at an ion guide positioned upstream of a mass filter during a predefined time period subsequent to MRM analysis of a current precursor ion selected by the mass filter,
determining a bandpass window for application to said ion guide based on a maximum m/z difference between an m/z of the current precursor ion and m/z ratios of said plurality of precursor ions to be analyzed in said subsequent time period, and
configuring the ion guide to provide said bandpass window.

2. The method of claim 1, wherein said ion guide comprises a plurality of rods arranged in a multipole configuration and configured for application of RF voltages thereto for providing a radial confining electromagnetic field, wherein said radial electromagnetic field provides a low mass cut off (LMCO) and a plurality of auxiliary electrodes configured for application of DC voltages thereto for providing a high mass cut off (HMCO) such that a combination of said LMCO and said HMCO provides said bandpass window.

3. The method of claim 2, wherein the step of configuring the ion guide to provide said bandpass window comprises adjusting the DC voltages applied to said auxiliary electrodes.

4. The method of claim 1, wherein the step of identifying the plurality of precursor ions comprises predicting an ion transit time through the ion guide for each of a set of precursor ions slated for MRM analysis and an ion transmission time associated with MRM analysis of each of said precursor ions.

5. The method of claim 4, wherein said step of determining the bandpass window further comprises utilizing said transit time and said ion transmission time.

6. The method of claim 4, wherein the step of determining the bandpass window comprises selecting a bandpass window having an m/z range greater than said maximum m/z difference.

7. The method of claim 2, wherein said auxiliary electrodes comprise a plurality of T-shaped electrodes.

8. The method of claim 1, wherein said predefined time period is in a range of about 1 ms to about 200 ms.

9. The method of claim 2, wherein said RF voltages have a frequency in a range of about 0.1 MHz to about 5 MHz.

10. The method of claim 2, wherein said DC voltages are in a range of about −1000 volts to about +1000 volts.

11. A mass spectrometer, comprising:
an ion guide configured to receive a plurality of ions, said ion guide having a plurality of rods arranged in a multipole configuration and configured for application of one or more RF voltages thereto for generating a radial confining electromagnetic field and having a plurality of auxiliary electrodes interspersed between said plurality of rods and configured for application of one or more DC voltages thereto for generating a passband window for controlling transmission of ions through the ion guide,
a mass filter positioned downstream of the ion guide for selecting precursor ions for MRM analysis,
a controller in communication with the ion guide and the mass filter,
wherein said controller is configured to adjust the bandpass of the ion guide based on a maximum m/z difference between an m/z of a current precursor ion under MRM analysis and m/z ratios of a plurality of precursor ions to be analyzed in a predefined time period subsequent to analysis of the current precursor ion.

12. The mass spectrometer of claim 11, further comprising a RF voltage source operating under control of said controller for applying RF voltages to said plurality of rods.

13. The mass spectrometer of claim 11, further comprising a DC voltage source operating under control of said controller for applying DC voltages to said auxiliary electrodes.

14. The mass spectrometer of claim 13, wherein said controller is configured to control said DC voltage source for adjusting DC voltages applied to said auxiliary electrodes for adjusting said bandpass window.

15. The mass spectrometer of claim 11, wherein said controller is configured to identify the m/z ratios of the plurality of the precursor ions to be analyzed in said predefined time period based on an ion transit time and ion transmission time associated with a set of precursor ions slated for MRM analysis.
